(19) United States
(12) Patent Application Publication
(10) Pub. No.: US 2026/0274106 A1
(43) Pub. Date: Sep. 17, 2026

(54) MEDIUM- AND LONG-TERM PREDICTION METHOD FOR ELECTRIC VEHICLE CHARGING LOAD IN CONSIDERATION OF ORDERLY CHARGING STRATEGY

(71) Applicant: Electric Power Research Institute of Hainan Power Grid Co., Ltd., Haikou (CN)

(72) Inventors: Songling PANG, Haikou (CN); Yunan ZHAO, Haikou (CN); Ruien ZHANG, Haikou (CN); Chenjia ZHANG, Haikou (CN); Meiyi HUO, Haikou (CN)

(21) Appl. No.: 19/664,128

(22) Filed: Apr. 30, 2026

Related U.S. Application Data
(63) Continuation of application No. PCT/CN2024/104106, filed on Jul. 6, 2024.

(30) Foreign Application Priority Data
Nov. 6, 2023 (CN) 202311469598.4

(51) Int. Cl. B60L 53/64; B60L 53/66; G05B 13/04; H02J 3/17; H02J 103/30

(52) U.S. Cl. CPC B60L 53/64; B60L 53/665; G05B 13/048; H02J 3/17; H02J 2103/30

(57) ABSTRACT

The present application discloses a medium- and long-term prediction method and system for an electric vehicle charging load in consideration of an orderly charging strategy, including: predicting a number of electric vehicles in a region, collecting daily driving mileage and power consumption mean values of the electric vehicles, and calculating a charging amount of the electric vehicles in a prediction year; determining, based on a Monte Carlo simulation method and travel patterns of the electric vehicles, a typical charging load curve of the electric vehicles in the region to be predicted; correcting the typical charging load curve of the electric vehicles in the region to be predicted according to an elasticity coefficient and a charging price in the prediction year; and obtaining the final electric vehicle charging load in the region to be predicted in the prediction year.

### CROSS-REFERENCE TO RELATED APPLICATIONS

The present application is a continuation of International Application No. PCT/CN2024/104106, filed on Jul. 6, 2024, which claims priority to Chinese Patent Application No. 202311469598.4, filed on Nov. 6, 2023, the entire disclosure of which is incorporated herein by reference.

### TECHNICAL FIELD

The present application relates to the technical field of electric vehicle charging, and in particular to a medium- and long-term prediction method and system for an electric vehicle charging load in consideration of an orderly charging strategy.

### BACKGROUND

With the continuous growth of global energy demand and the improvement of environmental protection awareness, the electric vehicle (EVs) technology has developed rapidly. Electric vehicles have gradually become one of important ways to solve energy crisis and reduce greenhouse gas emissions due to their characteristics of environmental protection and energy conservation. In recent years, with the rapid expansion of the electric vehicle market, charging infrastructure construction has also been rapidly followed up. However, unpredictability and volatility of an electric vehicle charging load pose new challenges to stable operation of a power grid. Traditional charging load prediction methods mainly rely on historical data and simple linear models which are difficult to accurately reflect charging behaviors of electric vehicle users and a trend of a future charging demand. These methods usually fail to consider complex factors such as charging prices and elastic responses of user charging behaviors, resulting in a large deviation between a prediction result and an actual load.

There are many shortcomings in predicting the electric vehicle charging load in the prior art. First, most methods fail to fully consider dynamic changes of the electric vehicle charging behaviors, ignoring time and spatial distribution characteristics of the charging load. Next, existing prediction methods are mostly based on static models, and lack analysis on charging price fluctuations and user behavior responses, which may lead to a problem of power grid overload in a peak period. In addition, there are often lack of effective data processing and analysis methods in predicting the charging load in the prior art, without accurately capturing randomness and complexity of the charging behaviors. In contrast, an orderly charging strategy proposed by the present application can predict the electric vehicle charging load more accurately by combining a Monte Carlo simulation method with a user's charging behavior law, and dynamically adjust the charging load according to a charging price and an elasticity coefficient of a prediction year. This not only effectively weakens a pressure on the power grid in the peak period, but also improves utilization efficiency of charging infrastructure.

There are the above problems in predicting the electric vehicle charging load in the prior art. The present application provides a medium- and long-term prediction method for an electric vehicle charging load in consideration of an orderly charging strategy, including: predicting a number of electric vehicles in a region, collecting daily driving mileage and power consumption mean values of the electric vehicles, and calculating a charging amount of the electric vehicles in a prediction year; determining, based on a Monte Carlo simulation method and travel patterns of the electric vehicles, a typical charging load curve of the electric vehicles in the region to be predicted; correcting, in consideration of an influence of the orderly charging strategy, the typical charging load curve of the electric vehicles in the region to be predicted according to an elasticity coefficient and a charging price in the prediction year; and obtaining, according to the charging amount of the electric vehicles in the prediction year and the corrected typical charging load curve of the electric vehicles in the prediction year, the final electric vehicle charging load in the region to be predicted in the prediction year.

### SUMMARY

In view of the problems mentioned above, the present application is proposed.

Therefore, the present application solves the technical problems that the existing charging load prediction methods are mostly based on static models, which have the problems of insufficient prediction accuracy, lack of dynamic responses, limited data processing capabilities, and possible power grid overload in a peak period.

In order to solve the above technical problems, the present application provides the following technical solutions: a medium- and long-term prediction method for an electric vehicle charging load in consideration of an orderly charging strategy includes:
predicting a number of electric vehicles in a region, collecting daily driving mileage and power consumption mean values of the electric vehicles, and calculating a charging amount of the electric vehicles in a prediction year;
determining, based on a Monte Carlo simulation method and travel patterns of the electric vehicles, a typical charging load curve of the electric vehicles in the region to be predicted;
correcting, in consideration of an influence of the orderly charging strategy, the typical charging load curve of the electric vehicles in the region to be predicted according to an elasticity coefficient and a charging price in the prediction year; and
obtaining, according to the charging amount of the electric vehicles in the prediction year and the corrected typical charging load curve of the electric vehicles in the prediction year, the final electric vehicle charging load in the region to be predicted in the prediction year.

As a preferred solution of the medium- and long-term prediction method for the electric vehicle charging load in consideration of the orderly charging strategy of the present application, in which the predicting a number of electric vehicles in a region, collecting daily driving mileage and power consumption mean values of the electric vehicles, and calculating a charging amount of the electric vehicles in a prediction year includes, where the electric vehicles comprise passenger cars, buses and special-purpose vehicles:
predicting, according to contents of economic and social development planning, urban and rural planning, land comprehensive utilization planning, environmental protection planning, intelligent transportation planning, cultural and eco-tourism planning, electric vehicle and charging service industry planning and smart grid planning in the region to be predicted, the number of the electric vehicles in the region to be predicted in the prediction year;
acquiring the daily driving mileage mean value of the electric vehicles and a power consumption of the electric vehicles; and
calculating the charging amount with respect to the electric vehicle charging load in the prediction year, wherein the formula is expressed as:

$$T C = 365 \times ( N 1 \times A 1 \times B 1 + N 2 \times A 2 \times B 2 + N 3 \times A 3 \times B 3 )$$

wherein a formula for a charging amount for the passenger car in the prediction year is expressed as:

$$T {C}_{1} = 365 \times {N}_{1} \times {A}_{1} \times {B}_{1}$$

a formula for a charging amount for the bus in the prediction year is expressed as:

$$T {C}_{2} = 365 \times {N}_{2} \times {A}_{2} \times {B}_{2}$$

a formula for a charging amount for the special-purpose vehicle in the prediction year is expressed as:

$$T {C}_{3} = 365 \times {N}_{3} \times {A}_{3} \times {B}_{3}$$

wherein N₁ is a number of the passenger cars in the prediction region in the prediction year; A₁ represents an average daily driving mileage mean value of the passenger cars; B₁ represents a power consumption per unit driving mileage of the passenger cars; TC₁ represents a total charging amount of the passenger cars in the prediction year; N₂ represents a number of the buses in the prediction region in the prediction year; A₂ represents an average daily driving mileage of the bus; B₂ represents a power consumption per unit driving mileage of the bus; TC₂ represents a total charging amount of the buses in the prediction year; N₃ represents a number of the special-purpose vehicles in the prediction region in the prediction year; B₃ represents a power consumption per unit driving mileage of the special-purpose vehicle; and TC₃ represents a total charging amount of the special-purpose vehicle in the prediction year.

As a preferred solution of the medium- and long-term prediction method for the electric vehicle charging load in consideration of the orderly charging strategy of the present application, in which the determining, based on a Monte Carlo simulation method and travel patterns of the electric vehicles, a typical charging load curve of the electric vehicles in the region to be predicted includes:
letting a daily driving distance s1 of passenger car in the region to be predicted conform to lognormal distribution, wherein a probability density function is expressed as:

$${f}_{s t 1} = \frac{1}{s 1 {σ}_{s 1} \sqrt{2 π}} exp ( - \frac{{( lns 1 - {μ}_{s 1} )}^{2}}{2 {σ}_{s 1}^{2}} )$$

wherein fₛ₁ represents the probability density function of the daily driving distance s1 of one passenger car in the region to be predicted; s1 is a specific value of the daily driving distance of one passenger car; σₛ₁ represents a logarithmic standard deviation of the daily driving distances s1 of the passenger cars; and μₛ₁ represents a logarithm mean value of the daily driving distances s1 of the passenger cars;
letting charging start times t1 of the passenger cars in the region to be predicted follow normal distribution, wherein the formula is expressed as:

$${f}_{t 1} = \frac{1}{{σ}_{t 1} \sqrt{2 π}} exp ( - \frac{{( t 1 - {μ}_{t 1} )}^{2}}{2 {σ}_{t 1}^{2}} )$$

wherein fₜ₁ represents probability distribution of charging start at a specific time t1; t1 represents a specific time of the passenger car starting to be charged; σₜ₁ represents a standard deviation of the charging start times t1 of the passenger cars; and μₜ₁ represents a mean value of the charging start times t1 of the passenger cars; and
obtaining travel pattern parameters μₛ₁, σₛ₁, μₜ₁ and σₜ₁ of the passenger car in the region to be predicted from historical charging data, and generating, by using the Monte Carlo simulation method, a typical charging load curve C₁=[C₁(1), C₁(2), C₁(3), . . . , C₁(n)] for the passenger cars in the region to be predicted on the precondition of the number N₁ of the passenger cars in the region to be predicted in the prediction year, wherein C₁(1), C₁(2), C₁(3), C₁(n) represent charging load powers of the passenger car in the region to be predicted at a 1^{st} time point, a 2^{nd} time point, a 3^{rd} time point and an n^{th} time point throughout a day respectively;
letting that a daily driving route of one bus in the region to be predicted is relatively fixed, wherein a probability density function of a daily driving distance s2 is expressed as:

$${f}_{s 2} = \frac{1}{{σ}_{s 2} \sqrt{2 π}} exp ( - \frac{{( s 2 - {μ}_{s 2} )}^{2}}{2 {σ}_{s 2}^{2}} )$$

Wherein fₛ₂ represents the daily driving distance of the bus in the region to be predicted; s2 represents a specific value of the daily driving distance of the bus; σₛ₂ is a standard deviation of the daily driving distances s2 of the buses; and u, represents a mean value of the daily driving distances s2 of the buses;
letting charging start times t2 of the buses in the region to be predicted follow uniform distribution within a given time period, wherein the formula is expressed as:

$${f}_{t 2} = \frac{1}{b - a} a < t 2 < b$$

wherein t2 represents a specific value of the bus starting to be charged; a represents a lower limit of the charging start time of one bus; fₛ₂ represents a probability density function of the charging start time t2 of the bus in the region to be predicted; and t2 represents a specific time of the bus starting to be charged;
obtaining travel pattern parameters μₛ₂, σₛ₂, a and b of the bus in the region to be predicted from historical charging data; and
generating, by using the Monte Carlo simulation method, a typical charging load curve for the bus in the region to be predicted on the precondition of the number of the buses in the region to be predicted in the prediction year, wherein C₂(1), C₂(2), C₂(3), C₂(n) represent charging load powers of the bus in the region to be predicted at a 1^{st} time point, a 2^{nd} time point, a 3^{rd} time point and an n^{th} time point throughout a day respectively; and
letting that a daily driving mileage of one special-purpose vehicle in the region to be predicted exhibits a significant fluctuation, wherein a probability density function of the daily driving distance s3 is expressed as:

$${f}_{s 3} = λ {e}^{- λ s 3}$$

wherein fₛ₃ represents the probability density function of the daily driving distance s3 of the special-purpose vehicle in the region to be predicted; s3 represents a specific value of the daily driving distance of the special-purpose vehicle; and λ represents a distribution parameter;
letting a charging start times t3 of the special-purpose vehicles in the region to be predicted follow normal distribution, wherein the formula is expressed as:

$${f}_{t 3} = \frac{1}{{σ}_{t 3} \sqrt{2 π}} exp ( - \frac{{( t 1 - {μ}_{t 3} )}^{2}}{2 {σ}_{t 3}^{2}} )$$

wherein fₜ₃ represents a probability density function of the charging start time t3 of the special-purpose vehicle in the region to be predicted; t3 represents a specific time of the special-purpose vehicle starting to be charged; σₜ₃ represents a standard deviation of the charging start times t3 of the special-purpose vehicles; and μₜ₃ represents a mean value of the charging start times t3 of the special-purpose vehicles;
obtaining travel pattern parameters λ, μₜ₃ and σₜ₃ of the special-purpose vehicle in the region to be predicted from historical charging data; and
generating, by using the Monte Carlo simulation method, a typical charging load curve for the special-purpose vehicle in the region to be predicted on the precondition of the number N₃ of the special-purpose vehicles in the region to be predicted in the prediction year,
wherein C₃(1), C₃(2), C₃(3), C₃(n) represent charging load powers of the special-purpose vehicle in the region to be predicted at a 1^{st} time point, a 2^{nd} time point, a 3^{rd} time point and an n^{th} time point throughout a day respectively.

As a preferred solution of the medium- and long-term prediction method for the electric vehicle charging load in consideration of the orderly charging strategy of the present application, in which the correcting, in consideration of an influence of the orderly charging strategy, the typical charging load curve of the electric vehicles in the region to be predicted according to an elasticity coefficient and a charging price in the prediction year includes: establishing a Nash equilibrium model for the passenger cars participating in orderly charging in the region to be predicted, and determining an elasticity coefficient α1 of the passenger car in the region to be predicted, where the formula is expressed as:

$${F}_{1} = - {\sum }_{i = 1}^{n} {P}_{1} ( i ) \cdot {Ch}_{1} ( i ) \cdot Δ t + {FI}_{1}$$

wherein F₁ represents a main profit of the passenger car participating in the orderly charging strategy; P₁ represents a charging price at an i^{th} time point throughout a day; Ch₁(i) represents a charging power at the i^{th} time point throughout a day; Δt represents an interval time between adjacent time points; and FI₁ represents an average daily charging cost of the passenger car not participating in orderly charging;
in a case of the passenger cars in the region to be predicted participating in the orderly charging strategy, a formula for a main profit available to the power grid may be expressed as:

$${F}_{2} = {T}_{1 a} \cdot max ( {C}_{1} ( i ) - {Ch}_{1} ( i ) ) + {α}_{1 b} \cdot max ( {C}_{1} ( i ) - {Ch}_{1} ( i ) ) \cdot {β}_{1 b} + {δ}_{1 c} \cdot max ( {C}_{1} ( i ) - {Ch}_{1} ( i ) )$$

wherein F₂ represents a main profit of the power grid after the passenger cars participate in the orderly charging strategy; T₁ₐ represents a cost per unit capacity of a transformer; max(C₁(i)-Ch₁(i)) represents a maximum charging power curtailment at the i^{th} time point throughout a day; α_{1b} represents a daily equivalent utilization coefficient of a distribution line where a charging station is located; β_{1b} represents a loss cost per unit power of the distribution line; and δ_{1c} represents a benefit derived from postponed power grid reconstruction engineering per unit power curtailment; and
during cooperative operation, all participating entities in the game seek to maximize own interests, and the Nash equilibrium model formula is expressed as follows:

$$\{ \begin{matrix}F = [ max ( {F}_{1} ) + max ( {F}_{2} ) ] \\ {F}_{1} > 0 ; {F}_{2} > 0\end{matrix}$$

wherein F represents a total profit of a system; max(F₁) represents a maximum profit available to the passenger car by means of the orderly charging strategy; max(F₂) represents a maximum profit available to the power grid by means of the orderly charging strategy for the passenger cars; F₁ represents a profit of the passenger car participating in the orderly charging strategy; F₂ represents a profit of the power grid after the passenger cars participate in the orderly charging strategy; F₁>0 represents the profit of the passenger car needing to be positive; F₂>0 represents the profit of the power grid needing to be positive.

As a preferred solution of the medium- and long-term prediction method for the electric vehicle charging load in consideration of the orderly charging strategy of the present application, in which the correcting, in consideration of an influence of the orderly charging strategy, the typical charging load curve of the electric vehicles in the region to be predicted according to an elasticity coefficient and a charging price in the prediction year further includes: obtaining an orderly charging power of the passenger car in the region to be predicted by solving the established Nash equilibrium model, including: simultaneously influencing F₁ and F₂ in the Nash equilibrium model by an orderly charging power sequence of the passenger cars at different times, which is a non-convex nonlinear optimization problem; converting the problem into two subproblems for solution, where one subproblem is to maximize a total benefit F₃ of the benefit derived from orderly charging of the passenger cars and the benefit available to the power grid, and the formula is expressed as:

$${F}_{3} = - {\sum }_{i = 1}^{n} {P}_{1} ( i ) \cdot {C}_{1} ( i ) \cdot Δ t + {FI}_{1} + {T}_{1 a} \cdot max ( {C}_{1} ( i ) - C {h}_{1} ( i ) ) + {α}_{1 b} \cdot max ( {C}_{1} ( i ) - C {h}_{1} ( i ) ) \cdot {β}_{1 b} + {δ}_{1 c} \cdot max ( {C}_{1} ( i ) - C {h}_{1} ( i ) )$$

wherein F₃ represents a comprehensive profit of the passenger car and the power grid following the orderly charging strategy; P₁(i) represents a charging price at the i^{th} time point throughout a day; Ch₁(i) represents a charging power at the i^{th} time point throughout a day; Δt represents an interval time between adjacent time points; FI₁ represents an average daily charging cost of the passenger car not participating in orderly charging; T₁ₐ represents the cost per unit capacity of the transformer; max(C₁(i)-Ch₁(i)) represents the maximum charging power curtailment at the i^{th} time point throughout a day; α₁ₐ represents the daily equivalent utilization coefficient of the distribution line where the charging station is located; β_{1b} represents the loss cost per unit power of the distribution line; and δ_{1c} represents the benefit derived from the postponed power grid reconstruction engineering per unit power curtailment; and
the other subproblem is to most equitably distributing the benefit derived from orderly charging of the passenger cars and the benefit available to the power grid, and the formula is expressed as:

$${F}_{4} = ln [ - {\sum }_{i = 1}^{n} {F}_{1} ( i ) \cdot {Cl}_{1} ( i ) \cdot Δ t + {FI}_{1} ] + ln [ {T}_{1 a} \cdot max ( {C}_{1} ( i ) ‐ {Cl}_{1} ( i ) ) ] + {c}_{1 b} \cdot max ( {C}_{1} ( i ) ‐ {Cl}_{1} ( i ) ) \cdot {β}_{1 b} + {δ}_{1 c} \cdot ( {C}_{1} ( i ) ‐ {Cl}_{1} ( i ) )$$

wherein F₄ represents a logarithmic comprehensive profit of the system; F₁(i) represents a charging price at the i^{th} time point; Cl₁(i) represents a charging power at the i^{th} time point; Δt represents an interval time between adjacent time points; FI₁ represents an average daily charging cost of the passenger car not participating in orderly charging; T₁ₐ represents the cost per unit capacity of the transformer; c_{1b} represents the daily equivalent utilization coefficient of the distribution line; β_{1b} represents the loss cost per unit power of the distribution line; and δ_{1c} represents the benefit derived from the postponed power grid reconstruction engineering per unit power curtailment.

As a preferred solution of the medium- and long-term prediction method for the electric vehicle charging load in consideration of the orderly charging strategy of the present application, in which the correcting, in consideration of an influence of the orderly charging strategy, the typical charging load curve of the electric vehicles in the region to be predicted according to an elasticity coefficient and a charging price in the prediction year further includes: solving the two subproblems by means of a conventional convex optimization algorithm to ensure maximize F₃ and F₄; completing solution of the established Nash equilibrium model; and yielding the charging power Ch₁(i) of the passenger car participating in the orderly charging strategy in the region to be predicted at the i^{th} time point throughout a day to obtain the elasticity coefficient α₁ of the passenger car in the region to be predicted, where the formula is expressed as:

$${α}_{1} = \frac{C {h}_{1} ( i )}{{C}_{1} ( i )}$$

the elasticity coefficient α₃ of the special-purpose vehicle in the region to be predicted is determined by using a Nash equilibrium theory, a benefit of the special-purpose vehicles participating in the orderly charging strategy in the region to be predicted is derived from the main profit F₃₁, and the formula is expressed as:

$${F}_{31} = {\sum }_{i = 1}^{n} {P}_{3} ( i ) \cdot C {h}_{3} ( i ) \cdot Δ t - {FI}_{3}$$

wherein F₃₁ represents a main profit of the special-purpose vehicle participating in the orderly charging strategy; P₃(i) represents a charging price at the i^{th} time point throughout a day; Ch₃(i) represents a charging power at the i^{th} time point throughout a day; Δt represents an interval time between adjacent time points; and FI₃ represents an average daily charging cost of the special-purpose vehicle not participating in orderly charging;
in a case of the special-purpose vehicles in the region to be predicted participating in the orderly charging strategy, a formula for a main profit F₃₂ available to the power grid may be expressed as:

$${F}_{32} = {T}_{3 a} \cdot max ( {C}_{3} ( i ) - {Ch}_{3} ( i ) ) + {α}_{3 b} \cdot max ( {C}_{3} ( i ) - {Ch}_{3} ( i ) ) \cdot {β}_{3 b} + {δ}_{3 c} \cdot max ( {C}_{3} ( i ) - {Ch}_{3} ( i ) )$$

wherein F₃₂ represents a main profit of the power grid after the special-purpose vehicles participate in the orderly charging strategy; T₃ₐ represents a cost per unit capacity of the transformer; C₃(i) represents a charging load curve value at the i^{th} time point throughout a day; Ch₃(i) represents a charging power at the i^{th} time point throughout a day; α_{3b} represents a daily equivalent utilization coefficient of the distribution line where the charging station is located; β_{3b} represents a loss cost per unit power of the distribution line; and δ_{3c} represents a benefit derived from postponed power grid reconstruction engineering per unit power curtailment; and
during cooperative operation, all participating entities in the game seek to maximize own interests, and the Nash equilibrium model is as follows:

$$\{ \begin{matrix}F = [ max ( {F}_{31} ) + max ( {F}_{32} ) ] \\ {F}_{31} > 0 ; {F}_{32} > 0\end{matrix}$$

yielding, by solving an optimization formula, the charging power Ch₃(i) of the special-purpose vehicle participating in orderly charging in the region to be predicted at the i^{th} time point throughout a day, and obtaining the elasticity coefficient α₃ of the passenger car in the region to be predicted, specifically as follows:

$${α}_{3} = \frac{C {h}_{3} ( i )}{{C}_{3} ( i )}$$

according to the elasticity coefficient α₁ of the passenger car in the region to be predicted and the charging price in the prediction year, P₁(1), P₁(2), P₁(3), and P₁(n) represent charging prices of the passenger car in the region to be predicted at the 1^{st} time point, the 2^{nd} time point, the 3^{rd} time point and the n^{th} time point throughout a day respectively;
a yielded typical charging load curve of the passenger cars in the region to be predicted is expressed as:

$${C}_{1 z} ( i ) = {α}_{1} \times \frac{max ( {P}_{1} ) + min ( {P}_{1} )}{2 {P}_{1} ( i )} \times {C}_{1} ( i ) , 1 \leq i \leq n$$

wherein C_{1z}=[C_{1z}(1), C_{1z}(2), C_{1z}(3), . . . , C_{1z}(n)], C_{1z}(1), C_{1z}(2), C_{1z}(3), C_{1z}(n) represent corrected charging load powers of the passenger cars in the region to be predicted at the 1^{st} time point, the 2^{nd} time point, the 3^{rd} time point and the n^{th} time point throughout a day respectively,
Wherein C_{1z}(i) represents an adjusted charging load power of the passenger car at the i^{th} time point throughout a day; α₁ represents an elasticity coefficient of the passenger car; max(P₁) represents a maximum charging price throughout a day; min(P₁) represents a minimum charging price throughout a day; P₁(i) represents a charging price at the i^{th} time point throughout a day; C₁(i) represents an original charging load power of the passenger car at the i^{th} time point throughout a day; and 1≤i≤n represents a range of the time point i; and
according to the elasticity coefficient α₃ of the special-purpose vehicle in the region to be predicted and the charging price P₃=[P₃(1), P₃(2), P₃(3), . . . , P₃(n in the prediction year)], P₃(1), P₃(2), P₃(3), P₃(n) represent charging prices of the special-purpose vehicle in the region to be predicted at the 1^{st} time point, the 2^{nd} time point, the 3^{rd} time point and the n^{th} time point throughout a day respectively;
a corrected typical charging load curve of the special-purpose vehicles in the region to be predicted is expressed as:

$${C}_{3} = [ {C}_{3} ( 1 ) , {C}_{3} ( 2 ) , {C}_{3} ( 3 ) , … , {C}_{3} ( n ) ]$$

$${C}_{3 z} = [ {C}_{3 z} ( 1 ) , {C}_{3 z} ( 2 ) , {C}_{3 z} ( 3 ) , … , {C}_{3 z} ( n ) ]$$

wherein C_{3z}(1), C_{3z}(2), C_{3z}(3), C_{3z}(n) represent corrected charging load powers of the special-purpose vehicle in the region to be predicted at a 1^{st} time point, a 2^{nd} time point, a 3^{rd} time point and an n^{th} time point throughout a day respectively;

$${C}_{3 z} ( i ) = {α}_{3} \times \frac{2 max ( {P}_{3} ) + min ( {P}_{3} )}{3 {P}_{3} ( i )} \times {C}_{3} ( i ) , 1 \leq i \leq n$$

wherein C_{3z}(i) represents an adjusted charging load power of the special-purpose vehicle at the i^{th} time point throughout a day; α₃ represents an elasticity coefficient of the special-purpose vehicle; max(P₃) represents a maximum charging price throughout a day; min(P₃) represents a minimum charging price throughout a day; P₃(i) represents a charging price at the i^{th} time point throughout a day; C₃(i) represents an original charging load power of the passenger car at the i^{th} time point throughout a day; and 1≤i≤n represents a range of the time point i.

As a preferred solution of the medium- and long-term prediction method for the electric vehicle charging load in consideration of the orderly charging strategy of the present application, in which the obtaining, according to the charging amount of the electric vehicles in the prediction year and the corrected typical charging load curve of the various electric vehicles in the prediction year, the final electric vehicle charging load in the region to be predicted in the prediction year includes: solving a charging load prediction coefficient F1 of the passenger car in the region to be predicted in the prediction year, specifically as follows:

$${F}_{1} = \frac{{N}_{1} \times {A}_{1}}{[ 365 \times \frac{24}{n} {\sum }_{i = 1}^{n} {C}_{1 z} ( i ) ]}$$

solving a charging load prediction coefficient F₂ of the bus in the region to be predicted in the prediction year, specifically as follows:

$${F}_{2} = \frac{{N}_{2} \times {A}_{2}}{[ 365 \times \frac{24}{n} {\sum }_{i = 1}^{n} {C}_{2} ( i ) ]}$$

solving a charging load prediction coefficient F₃ of the special-purpose vehicle in the region to be predicted in the prediction year, specifically as follows:

$${F}_{3} = \frac{{N}_{3} \times {A}_{3}}{[ 365 \times \frac{24}{n} {\sum }_{i = 1}^{n} {C}_{3 z} ( i ) ]}$$

and yielding a final electric vehicle charging load in the region to be predicted in the prediction year LP=[LP(1), LP(2), LP(3), . . . , LP(n)], specifically as follows:

$$LP ( i ) = {F}_{1} \times {C}_{1 z} ( i ) + {F}_{2} \times {C}_{2} ( i ) + {F}_{3} \times {C}_{3 z} ( i ) \qquad 1 < i \leq n$$

wherein F₁ represents the charging load prediction coefficient of the passenger car; N₁ represents the number of the passenger cars in the prediction region in the prediction year; A₁ represents the average daily driving mileage of the passenger car; F₂ represents the charging load prediction coefficient of the bus; N₂ represents the number of the buses in the prediction region in the prediction year; A₂ represents the average daily driving mileage of the bus; F₃ represents the charging load prediction coefficient of the special-purpose vehicle; N₃ represents the number of the special-purpose vehicles in the prediction region in the prediction year; A₃ represents the average daily driving mileage of the special-purpose vehicle.

A medium- and long-term prediction system for an electric vehicle charging load in consideration of an orderly charging strategy includes:
a prediction module, configured to predict a number of electric vehicles in a region, collecting daily driving mileage and power consumption mean values of the electric vehicles, and calculating a charging amount of the electric vehicles in a prediction year;
a determining module, configured to determine, based on a Monte Carlo simulation method and travel patterns of the electric vehicles, a typical charging load curve of the electric vehicles in the region to be predicted;
a correcting module, configured to correct, in consideration of an influence of the orderly charging strategy, the typical charging load curve of the electric vehicles in the region to be predicted according to an elasticity coefficient and a charging price in the prediction year; and
a result module, configured to obtain, according to the charging amount of the electric vehicles in the prediction year and the corrected typical charging load curve of the electric vehicles in the prediction year, the final electric vehicle charging load in the region to be predicted in the prediction year.

A computer device, including a memory and a processor, where the memory has a computer program stored thereon, and the processor implements, when executing the computer program, steps of a medium- and long-term prediction method for an electric vehicle charging load in consideration of an orderly charging strategy of the present application.

A computer-readable storage medium, with computer programs stored thereon; and the steps of the medium- and long-term prediction method for an electric vehicle charging load in consideration of an orderly charging strategy of the present application are achieved when the computer programs are executed by the processor.

The present application has the beneficial effects that: the medium- and long-term prediction method for the electric vehicle charging load in consideration of the orderly charging strategy provided by the present application, by combining the Monte Carlo simulation method with the travel patterns of the electric vehicles, can predict the electric vehicle charging load more accurately; dynamically correcting the typical charging load curve improves a dynamic response ability of prediction, and weakens an impact of a peak load on the power grid; in this way, the overload problem of the power grid in the peak period is avoided, and operation stability and efficiency of the power grid are improved; and optimizing charging time distribution and load management increases a utilization rate of charging infrastructure, which avoids excessive congestion of the charging station in the peak period and resource waste during idle time, and efficiently uses resources.

### BRIEF DESCRIPTION OF DRAWINGS

To more clearly describe the technical solutions of the embodiments of the present application, the accompanying drawings required to describe the embodiments are briefly described below. Apparently, the accompanying drawings described below are only some embodiments of the present application. Those skilled in the art may further obtain Other drawings based on these accompanying drawings without inventive effort.

FIG. 1 is an overall flowchart of a medium- and long-term prediction method for an electric vehicle charging load in consideration of an orderly charging strategy provided by a first embodiment of the present application.

### DETAILED DESCRIPTION OF THE EMBODIMENTS

In order to make the aforementioned purposes, features and advantages of the present application more apparent and comprehensible, detailed descriptions of specific implementations of the present application are provided below in conjunction with the appended drawings. Apparently, the described embodiments are merely a part of the embodiments of the present application, rather than all embodiments. On the basis of the embodiments of the present application, all other embodiments obtained by those of ordinary skill in the art without creative efforts shall fall within the protection scope of the present application.

### Embodiment 1

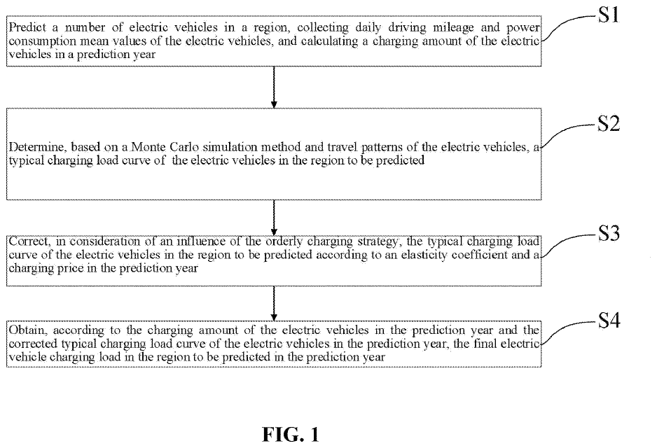

Referring to FIG. 1, it is one embodiment of the present application, providing a medium- and long-term prediction method for an electric vehicle charging load in consideration of an orderly charging strategy, including:
S1: predicting a number of electric vehicles in a region, collecting daily driving mileage and power consumption mean values of the electric vehicles, and calculating a charging amount of the electric vehicles in a prediction year.

The electric vehicles include passenger cars, buses and special-purpose vehicles.

The number of the electric vehicles in the region to be predicted in the prediction year is predicted according to contents of economic and social development planning, urban and rural planning, land comprehensive utilization planning, environmental protection planning, intelligent transportation planning, cultural and eco-tourism planning, electric vehicle and charging service industry planning and smart grid planning in the region to be predicted.

The daily driving mileage mean value of the electric vehicles and a power consumption of the electric vehicles are acquired.
calculating the charging amount with respect to the electric vehicle charging load in the prediction year, wherein the formula is expressed as:

$$TC = 365 \times ( N 1 \times A 1 \times B 1 + N 2 \times A 2 \times B 2 + N 3 \times A 3 \times B 3 )$$

wherein a formula for a charging amount for the passenger car in the prediction year is expressed as:

$${TC}_{1} = 365 \times {N}_{1} \times {A}_{1} \times {B}_{1}$$

a formula for a charging amount for the bus in the prediction year is expressed as:

$${TC}_{2} = 365 \times {N}_{2} \times {A}_{2} \times {B}_{2}$$

a formula for a charging amount for the special-purpose vehicle in the prediction year is expressed as:

$${TC}_{3} = 365 \times {N}_{3} \times {A}_{3} \times {B}_{3}$$

wherein N₁ is a number of the passenger cars in the prediction region in the prediction year; A₁ represents an average daily driving mileage mean value of the passenger cars; B₁ represents a power consumption per unit driving mileage of the passenger cars; TC represents a total charging amount of the passenger cars in the prediction year; N₂ represents a number of the buses in the prediction region in the prediction year; A₂ represents an average daily driving mileage of the bus; B₂ represents a power consumption per unit driving mileage of the bus; TC₂ represents a total charging amount of the buses in the prediction year; N₃ represents a number of the special-purpose vehicles in the prediction region in the prediction year; B₃ represents a power consumption per unit driving mileage of the special-purpose vehicle; and TC₃ represents a total charging amount of the special-purpose vehicle in the prediction year.

By collecting and analyzing information such as detailed planning data, a number of vehicles, a driving mileage and a power consumption, the charging amount of the electric vehicles in the prediction year is calculated. This method takes into account a variety of factors and variables to ensure accuracy and reliability of prediction results.

Through detailed data collection and analysis, charging demands of the electric vehicles in the future can be predicted more accurately, which provides reliable data support for power grid planning and management. The method takes into account various factors such as a vehicle type, the driving mileage, and the power consumption, making the prediction results more comprehensive and detailed. The prediction results can be used for guiding charging infrastructure construction and power grid load management, so as to avoid resource waste and power grid overload. Accurate load prediction can optimize charging time and load distribution, and improve the utilization efficiency of the power grid and the charging facilities. The data and the prediction results can provide a basis for governments and relevant institutions to formulate relevant policies and then promote healthy development of the electric vehicle industry.
S2: determining, based on a Monte Carlo simulation method and travel patterns of the electric vehicles, a typical charging load curve of the electric vehicles in the region to be predicted.
letting a daily driving distance s1 of passenger car in the region to be predicted conform to lognormal distribution, wherein a probability density function is expressed as:

$${f}_{st 1} = \frac{1}{s 1 {σ}_{s 1} \sqrt{2 π}} exp ( - \frac{{( lns 1 - {μ}_{s 1} )}^{2}}{2 {σ}_{s 1}^{2}} )$$

where fₛ₁ represents the probability density function of the daily driving distance s1 of the passenger car in the region to be predicted; s1 is a specific value of the daily driving distance of the passenger car; σₛ₁ represents a logarithmic standard deviation of the daily driving distances s1 of the passenger cars; and μₛ₁ represents a logarithm mean value of the daily driving distances s1 of the passenger cars.
letting charging start times t1 of the passenger cars in the region to be predicted follow normal distribution, wherein the formula is expressed as:

$${f}_{t 1} = \frac{1}{{σ}_{t 1} \sqrt{2 π}} exp ( - \frac{{( t 1 - {μ}_{t 1} )}^{2}}{2 {σ}_{t 1}^{2}} )$$

where fₜ₁ represents probability distribution of charging start at a specific time t1; t1 represents a specific time of the passenger car starting to be charged; σₜ₁ represents a standard deviation of the charging start times t1 of the passenger cars; and μ^{t1} represents a mean value of the charging start times t1 of the passenger cars.

Travel pattern parameters μₛ₁, σₛ₁, μₜ₁ and σₜ₁ of the passenger car in the region to be predicted is obtained from historical charging data; and by using the Monte Carlo simulation method, a typical charging load curve C₁=[C₁(1), C₁(2), C₁(3), . . . , C₁(n)] for the passenger car in the region to be predicted is generated on the precondition of the number N₁ of the passenger cars in the region to be predicted in the prediction year, where C₁(1), C₁(2), C₁(3), C₁(n) represent charging load powers of the passenger car in the region to be predicted at a 1^{st} time point, a 2^{nd} time point, a 3^{rd} time point and an n^{th} time point throughout a day respectively.
letting that a daily driving route of one bus in the region to be predicted is relatively fixed, wherein a probability density function of a daily driving distance s2 is expressed as:

$${f}_{s 2} = \frac{1}{{σ}_{s 2} \sqrt{2 π}} exp ( - \frac{{( s 2 - {μ}_{s 2} )}^{2}}{2 {σ}_{s 2}^{2}} )$$

where fₛ₂ represents the daily driving distance of the bus in the region to be predicted; s2 represents a specific value of the daily driving distance of the bus; σₛ₂ is a standard deviation of the daily driving distances s2 of the buses; and μₛ₂ represents a mean value of the daily driving distances s2 of the buses.
letting charging start times t2 of the buses in the region to be predicted follow uniform distribution within a given time period, wherein the formula is expressed as:

$${f}_{t 2} = \frac{1}{b - a} \qquad a < t 2 < b$$

where t2 represents a specific time of one bus starting to be charged; a represents a lower limit of the charging start time of the bus; fₛ₂ represents a probability density function of the charging start time t2 of the bus in the region to be predicted; and t2 represents a specific time of the bus starting to be charged.

Travel pattern parameters μₛ₂, σₛ₂, a and b of the bus in the region to be predicted from historical charging data are obtained.

By using the Monte Carlo simulation method, a typical charging load curve for the bus in the region to be predicted is generated on the precondition of the number of the buses in the region to be predicted in the prediction year, where C₂(1), C₂(2), C₂(3), C₂(n) represent charging load powers of the bus in the region to be predicted at a 1^{st} time point, a 2^{nd} time point, a 3^{rd} time point and an n^{th} time point throughout a day respectively.
letting that a daily driving mileage of one special-purpose vehicle in the region to be predicted exhibits a significant fluctuation, wherein a probability density function of the daily driving distance s3 is expressed as:

$${f}_{s 3} = λ {e}^{- λ s 3}$$

where fₛ₃ represents the probability density function of the daily driving distance s3 of the special-purpose vehicle in the region to be predicted; s3 represents a specific value of the daily driving distance of the special-purpose vehicle; and λ represents a distribution parameter.
letting a charging start times t3 of the special-purpose vehicles in the region to be predicted follow normal distribution, wherein the formula is expressed as:

$${f}_{t 3} = \frac{1}{{σ}_{t 3} \sqrt{2 π}} exp ( - \frac{{( t 1 - {μ}_{t 3} )}^{2}}{2 {σ}_{t 3}^{2}} )$$

where fₜ₃ represents a probability density function of the charging start time t3 of the special-purpose vehicle in the region to be predicted; t3 represents a specific time of the special-purpose vehicle starting to be charged; σₜ₃ represents a standard deviation of the charging start times t3 of the special-purpose vehicles; and μₜ₃ represents a mean value of the charging start times t3 of the special-purpose vehicles.

Travel pattern parameters λ, μₜ₃ and σₜ₃ of the special-purpose vehicle in the region to be predicted are obtained from historical charging data.

By using the Monte Carlo simulation method, a typical charging load curve for the special-purpose vehicle in the region to be predicted is generated on the precondition of the number N₃ of the special-purpose vehicles in the region to be predicted in the prediction year, where C₃(1), C₃(2), C₃(3), C₃(n) represent charging load powers of the special-purpose vehicle in the region to be predicted at a 1^{st} time point, a 2^{nd} time point, a 3^{rd} time point and an n^{th} time point throughout a day respectively.

The charging behaviors of the electric vehicles can be simulated more accurately by using Monte Carlo simulation method, lognormal distribution, normal distribution, uniform distribution and exponential distribution to describe the driving distances and the charging times of the electric vehicles. These distribution functions can capture the randomness and the complexity of the charging behaviors of the electric vehicles, making the prediction results closer to actual situations.

Simulating real charging behaviors of the electric vehicles can improve accuracy of charging load prediction, which provides reliable data support for power grid planning and management. The method takes into account distribution characteristics of different vehicle types, driving distances and the charging times, making the prediction results more comprehensive and detailed. Accurately predicting the electric vehicle charging load can optimize load management of the power grid, weaken the pressure of a peak load on the power grid, and improve the operation stability and efficiency of the power grid. The prediction results can be used for guiding layout and construction of the charging infrastructure, so as to avoid resource waste and power grid overload. Flexibility of the Monte Carlo simulation method makes it possible for simulation for multiple times according to different input parameters and assumptions, so as to evaluate charging load distribution in different scenarios and provide multiple decision support.

S3: correcting, in consideration of an influence of the orderly charging strategy, the typical charging load curve of the electric vehicles in the region to be predicted according to an elasticity coefficient and a charging price in the prediction year.

A Nash equilibrium model for the passenger cars participating in orderly charging in the region to be predicted is established, and an elasticity coefficient α1 of the passenger car in the region to be predicted is determined, where the formula is expressed as:

$${F}_{1} = - {\sum }_{i = 1}^{n} {P}_{1} ( i ) \cdot {Ch}_{1} ( i ) \cdot Δ t + {FI}_{1}$$

where F₁ represents a main profit of the passenger car participating in the orderly charging strategy; P₁ represents a charging price at an i^{th} time point throughout a day; Ch₁(i) represents a charging power at the i^{th} time point throughout a day; Δt represents an interval time between adjacent time points; and FI₁ represents an average daily charging cost of the passenger car not participating in orderly charging.
in a case of the passenger cars in the region to be predicted participating in the orderly charging strategy, a formula for a main profit available to the power grid may be expressed as:

$${F}_{2} = {T}_{1 a} \cdot max ( {C}_{1} ( i ) - {Ch}_{1} ( i ) ) + {α}_{1 b} \cdot max ( {C}_{1} ( i ) - {Ch}_{1} ( i ) ) \cdot {β}_{1 b} + {δ}_{1 c} \cdot max ( {C}_{1} ( i ) - {Ch}_{1} ( i ) )$$

where F₂ represents a main profit of the power grid after the passenger cars participate in the orderly charging strategy; T₁ₐ represents a cost per unit capacity of a transformer; max(C₁(i)-Ch₁(i)) represents a maximum charging power curtailment at the i^{th} time point throughout a day; α_{1b} represents a daily equivalent utilization coefficient of a distribution line where a charging station is located; β_{1b} represents a loss cost per unit power of the distribution line; and δ_{1c} represents a benefit derived from postponed power grid reconstruction engineering per unit power curtailment.
during cooperative operation, all participating entities in the game seek to maximize own interests, and the Nash equilibrium model formula is expressed as follows:

$$\{ \begin{matrix}F = [ max ( {F}_{1} ) + max ( {F}_{2} ) ] \\ {F}_{1} > 0 ; {F}_{2} > 0\end{matrix}$$

wherein F represents a total profit of a system; max(F₁) represents a maximum profit available to the passenger car by means of the orderly charging strategy; max(F₂) represents a maximum profit available to the power grid by means of the orderly charging strategy for the passenger cars; F₁ represents a profit of the passenger car participating in the orderly charging strategy; F₂ represents a profit of the power grid after the passenger cars participate in the orderly charging strategy; F₁>0 represents the profit of the passenger car needing to be positive; F₂>0 represents the profit of the power grid needing to be positive.

The obtaining an orderly charging power of the passenger car in the region to be predicted by solving the established Nash equilibrium model, including: simultaneously influencing F₁ and F₂ in the Nash equilibrium model by an orderly charging power sequence of the passenger cars at different times, which is a non-convex nonlinear optimization problem; converting the problem into two subproblems for solution, where one subproblem is to maximize a total benefit F₃ of the benefit derived from orderly charging of the passenger cars and the benefit available to the power grid, and the formula is expressed as:

$${F}_{3} = - {\sum }_{i = 1}^{n} {P}_{1} ( i ) \cdot {Ch}_{1} ( i ) \cdot Δ t + {FI}_{1} + {T}_{1 a} \cdot max ( {C}_{1} ( i ) - {Ch}_{1} ( i ) ) + {α}_{1 b} \cdot max ( {C}_{1} ( i ) - {Ch}_{1} ( i ) ) \cdot {β}_{1 b} + {δ}_{1 c} \cdot max ( {C}_{1} ( i ) - {Ch}_{1} ( i ) )$$

where F₃ represents a comprehensive profit of the passenger car and the power grid following the orderly charging strategy; P₁(i) represents a charging price at the i^{th} time point throughout a day; Ch₁(i) represents a charging power at the i^{th} time point throughout a day; Δt represents an interval time between adjacent time points; FI₁ represents an average daily charging cost of the passenger car not participating in orderly charging; T₁ₐ represents the cost per unit capacity of the transformer; max(C₁(i)-Ch₁(i)) represents the maximum charging power curtailment at the i^{th} time point throughout a day; α_{1b} represents the daily equivalent utilization coefficient of the distribution line where the charging station is located; β_{1b} represents the loss cost per unit power of the distribution line; and δ_{1c} represents the benefit derived from the postponed power grid reconstruction engineering per unit power curtailment.
the other subproblem is to most equitably distributing the benefit derived from orderly charging of the passenger cars and the benefit available to the power grid, and the formula is expressed as:

$${F}_{4} = ln [ - {\sum }_{i = 1}^{n} {F}_{1} ( i ) \cdot {Cl}_{1} ( i ) \cdot Δ t + {FI}_{1} ] + ln [ {T}_{1 a} \cdot max ( {C}_{1} ( i ) ‐ {Cl}_{1} ( i ) ) ] + {c}_{1 b} \cdot max ( {C}_{1} ( i ) - {Cl}_{1} ( i ) ) \cdot {β}_{1 b} + {δ}_{1 c} \cdot max ( {C}_{1} ( i ) - {Cl}_{1} ( i ) )$$

wherein F₄ represents a logarithmic comprehensive profit of the system; F₁(i) represents a charging price at the i^{th} time point; Cl₁(i) represents a charging power at the i^{th} time point; Δt represents an interval time between adjacent time points; FI₁ represents an average daily charging cost of the passenger car not participating in orderly charging; T₁ₐ represents the cost per unit capacity of the transformer; c_{1b} represents the daily equivalent utilization coefficient of the distribution line; β_{1b} represents the loss cost per unit power of the distribution line; and δ_{1c} represents the benefit derived from the postponed power grid reconstruction engineering per unit power curtailment.

The two subproblems are solved by means of a conventional convex optimization algorithm to ensure maximize F₃ and F₄; solution of the established Nash equilibrium model is completed; and the charging power Ch₁(i) of the passenger car participating in the orderly charging strategy in the region to be predicted at the i^{th} time point throughout a day is yielded to obtain the elasticity coefficient α₁ of the passenger car in the region to be predicted, where the formula is expressed as:

$${α}_{1} = \frac{{Ch}_{1} ( i )}{{C}_{1} ( i )}$$

the elasticity coefficient α₃ of the special-purpose vehicle in the region to be predicted is determined by using a Nash equilibrium theory, a benefit of the special-purpose vehicles participating in the orderly charging strategy in the region to be predicted is derived from the main profit F₃₁, and the formula is expressed as:

$${F}_{31} = {\sum }_{i = 1}^{n} {P}_{3} ( i ) \cdot {Ch}_{3} ( i ) \cdot Δ t - {FI}_{3}$$

where F₃₁ represents a main profit of the special-purpose vehicle participating in the orderly charging strategy; P₃(i) represents a charging price at the i^{th} time point throughout a day; Ch₃(i) represents a charging power at the i^{th} time point throughout a day; Δt represents an interval time between adjacent time points; and FI₃ represents an average daily charging cost of the special-purpose vehicle not participating in orderly charging.
in a case of the special-purpose vehicles in the region to be predicted participating in the orderly charging strategy, a formula for a main profit F₃₂ available to the power grid may be expressed as:

$${F}_{32} = {T}_{3 a} \cdot max ( {C}_{3} ( i ) - {Ch}_{3} ( i ) ) + {α}_{3 b} \cdot max ( {C}_{3} ( i ) - {Ch}_{3} ( i ) ) \cdot {β}_{3 b} + {δ}_{3 c} \cdot max ( {C}_{3} ( i ) - {Ch}_{3} ( i ) )$$

where F₃₂ represents a main profit of the power grid after the special-purpose vehicles participate in the orderly charging strategy; T₃ₐ represents a cost per unit capacity of the transformer; C₃(i) represents a charging load curve value at the i^{th} time point throughout a day; Ch₃(i) represents a charging power at the i^{th} time point throughout a day; α_{3b} represents a daily equivalent utilization coefficient of the distribution line where the charging station is located; B₃₁ represents a loss cost per unit power of the distribution line; and δ_{3c} represents a benefit derived from postponed power grid reconstruction engineering per unit power curtailment.
during cooperative operation, all participating entities in the game seek to maximize own interests, and the Nash equilibrium model is as follows:

$$\{ \begin{matrix}F = [ max ( {F}_{31} ) + max ( {F}_{32} ) ] \\ {F}_{31} > 0 ; {F}_{32} > 0\end{matrix}$$

yielding, by solving an optimization formula, the charging power Ch₃(i) of the special-purpose vehicle participating in orderly charging in the region to be predicted at the i^{th} time point throughout a day, and obtaining the elasticity coefficient α₃ of the passenger car in the region to be predicted, specifically as follows:

$${α}_{3} = \frac{{Ch}_{3} ( i )}{{C}_{3} ( i )}$$

according to the elasticity coefficient α₁ of the passenger car in the region to be predicted and the charging price in the prediction year, P₁(1), P₁(2), P₁(3), and P₁(n) represent charging prices of the passenger car in the region to be predicted at the 1^{st} time point, the 2^{nd} time point, the 3^{rd} time point and the n^{th} time point throughout a day respectively.
a yielded typical charging load curve of the passenger cars in the region to be predicted is expressed as:

$${C}_{1 z} ( i ) = {α}_{1} \times \frac{max ( {P}_{1} ) + min ( {P}_{1} )}{2 {P}_{1} ( i )} \times {C}_{1} ( i ) , 1 \leq i \leq n$$

where C_{1z}=[C_{1z}(1), C_{1z}(2), C_{1z}(3), . . . , C_{1z}(n)], C_{1z}(1), C_{1z}(2), C_{1z}(3), C_{1z}(n) represent corrected charging load powers of the passenger car in the region to be predicted at the 1^{st} time point, the 2^{nd} time point, the 3^{rd} time point and the n^{th} time point throughout a day respectively,
where C_{1z}(i) represents an adjusted charging load power of the passenger car at the i^{th} time point throughout a day; α₁ represents an elasticity coefficient of the passenger car; max(P₁) represents a maximum charging price throughout a day; min (P₁) represents a minimum charging price throughout a day; P₁(i) represents a charging price at the i^{th} time point throughout a day; C₁(i) represents an original charging load power of the passenger car at the i^{th} time point throughout a day; and 1≤i≤n represents a range of the time point i.

According to the elasticity coefficient α₃ of the special-purpose vehicle in the region to be predicted and the charging price P₃=[P₃(1), P₃(2), P₃(3), . . . , P₃(n in the prediction year)], P₃(1), P₃(2), P₃(3), P₃(n) represent charging prices of the special-purpose vehicle in the region to be predicted at the 1^{st} time point, the 2^{nd} time point, the 3^{rd} time point and the n^{th} time point throughout a day respectively.
a corrected typical charging load curve of the special-purpose vehicles in the region to be predicted is expressed as:

$${C}_{3} = [ {C}_{3} ( 1 ) , {C}_{3} ( 2 ) , {C}_{3} ( 3 ) , … , {C}_{3} ( n ) ]$$

$${C}_{3 z} = [ {C}_{3 z} ( 1 ) , {C}_{3 z} ( 2 ) , {C}_{3 z} ( 3 ) , … , {C}_{3 z} ( n ) ]$$

wherein C_{3z}(1), C_{3z}(2), C_{3z}(3), C_{3z}(n) represent corrected charging load powers of the special-purpose vehicle in the region to be predicted at a 1^{st} time point, a 2^{nd} time point, a 3^{rd} time point and an n^{th} time point throughout a day respectively;

$${C}_{3 z} ( i ) = {α}_{3} \times \frac{2 max ( {P}_{3} ) + min ( {P}_{3} )}{3 {P}_{3} ( i )} \times {C}_{3} ( i ) , 1 \leq i \leq n$$

wherein C_{3z}(i) represents an adjusted charging load power of the special-purpose vehicle at the i^{th} time point throughout a day; α₃ represents an elasticity coefficient of the special-purpose vehicle; max(P₃) represents a maximum charging price throughout a day; min(P₃) represents a minimum charging price throughout a day; P₃(i) represents a charging price at the i^{th} time point throughout a day; C₃(i) represents an original charging load power of the passenger car at the i^{th} time point throughout a day; and 1≤i≤n represents a range of the time point i.

Through detailed mathematical models and formulas, the electric vehicle charging load can be predicted more accurately, so as to improve the prediction accuracy. Optimizing the charging strategy can smooth the load curve, reduce the peak load of the power grid, and improve the operation stability and efficiency of the power grid. Dynamically adjusting the charging strategy can maximize the profits of passenger cars and the power grid, which increases an economic benefit. Accurately predicting and optimizing the charging load can avoid resource waste and rationally configure the charging infrastructure. Providing reliable data and analysis provides a scientific basis for policy formulation, which promotes healthy development of the electric vehicle industry.

S4: obtaining, according to the charging amount of the electric vehicles in the prediction year and the corrected typical charging load curve of the electric vehicles in the prediction year, the final electric vehicle charging load in the region to be predicted in the prediction year.

A charging load prediction coefficient F1 of the passenger car in the region to be predicted in the prediction year is solved, specifically as follows:

$${F}_{1} = \frac{{N}_{1} \times {A}_{1}}{[ 365 \times \frac{24}{n} {\sum }_{i = 1}^{n} {C}_{1 z} ( i ) ]}$$

solving a charging load prediction coefficient F₂ of the bus in the region to be predicted in the prediction year, specifically as follows:

$${F}_{2} = \frac{{N}_{2} \times {A}_{2}}{[ 365 \times \frac{24}{n} {\sum }_{i = 1}^{n} {C}_{2} ( i ) ]}$$

solving a charging load prediction coefficient F₃ of the special-purpose vehicle in the region to be predicted in the prediction year, specifically as follows:

$${F}_{3} = \frac{{N}_{3} \times {A}_{3}}{[ 365 \times \frac{24}{n} {\sum }_{i = 1}^{n} {C}_{3 z} ( i ) ]}$$

and yielding a final electric vehicle charging load in the region to be predicted in the prediction year LP=[LP(1), LP(2), LP(3), . . . , LP(n)], specifically as follows:

$$LP ( i ) = {F}_{1} \times {C}_{1 z} ( i ) + {F}_{2} \times {C}_{2} ( i ) + {F}_{3} \times {C}_{3 z} ( i ) \qquad 1 \leq i \leq n$$

wherein F₁ represents the charging load prediction coefficient of the passenger car; N₁ represents the number of the passenger cars in the prediction region in the prediction year; A₁ represents the average daily driving mileage of the passenger car; F₂ represents the charging load prediction coefficient of the bus; N₂ represents the number of the buses in the prediction region in the prediction year; A₂ represents the average daily driving mileage of the bus; F₃ represents the charging load prediction coefficient of the special-purpose vehicle; N₃ represents the number of the special-purpose vehicles in the prediction region in the prediction year; A₃ represents the average daily driving mileage of the special-purpose vehicle.

Taking into account various factors such as numbers of different types of vehicles, the driving mileage, and the charging load makes the prediction results more comprehensive and detailed. Calculating the charging load prediction coefficients of different types of vehicles, can reflect charging demands of various vehicles at different time points more accurately, which improves accuracy of overall prediction. The prediction results can be used for optimizing planning and management of the power grid and the charging infrastructure, so as to ensure equitable distribution of resources, and avoid power grid overload caused by the peak load. Accurately predicting the charging load can reduce construction and operation costs of the charging infrastructure, and improve the operation efficiency of the power grid and the utilization rate of the charging facilities. Providing reliable data support provides a scientific basis for the governments and the relevant institutions to formulate policies, which promotes healthy development of the electric vehicle industry.

In another aspect, the embodiment further provides a medium- and long-term prediction system for an electric vehicle charging load in consideration of an orderly charging strategy, including:
a prediction module, configured to predict a number of electric vehicles in a region, collecting daily driving mileage and power consumption mean values of the electric vehicles, and calculating a charging amount of the electric vehicles in a prediction year;
a determining module, configured to determine, based on a Monte Carlo simulation method and travel patterns of the electric vehicles, a typical charging load curve of the electric vehicles in the region to be predicted;
a correcting module, configured to correct, in consideration of an influence of the orderly charging strategy, the typical charging load curve of the electric vehicles in the region to be predicted according to an elasticity coefficient and a charging price in the prediction year; and
a result module, configured to obtain, according to the charging amount of the electric vehicles in the prediction year and the corrected typical charging load curve of the electric vehicles in the prediction year, the final electric vehicle charging load in the region to be predicted in the prediction year.

If a function is implemented in a form of a software functional unit, and sold or used as an independent product, the above function may be stored in a computer-readable storage medium. Based on this understanding, the technical solution of the present application essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present application. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of this specification, the “computer-readable medium” may be any device that may contain, store, communicate, propagate or transmit a program for use by the instruction execution systems, the apparatuses, or the devices or in a combination manner.

More specific examples (non-exhaustive list) of the computer-readable medium may include the following: an electrical connection (an electronic apparatus) with one or more wires, a portable computer disk case (a magnetic apparatus), a Random Access Memory (RAM), a Read-Only Memory (ROM), an Erasable Programmable Read-Only Memory (EPROM or flash memory), an optical fiber, and a portable Compact Disk Read-Only Memory (CDROM). In addition, the computer-readable medium may even be paper or other appropriate media on which the program may be printed. It because that the program may be acquired electronically, for example, by optically scanning the paper or other media, followed by editing, interpretation or, if necessary, other appropriate processing ways, and then stored in a computer memory.

It should be understood that, each part of the present application may be realized by hardware, software, firmware or a combination thereof. In the above implementation manners, a plurality of steps or methods may be realized by software or firmware stored in the memory and executed by the appropriate instruction execution systems. For example, if the plurality of steps or methods are realized by hardware, as in another implementation manner, the plurality of steps or methods may be realized by any one of the following technologies which are well known in the art or a combination thereof: a discrete logic circuit with a logic gate circuit for realizing a logic function for a data signal, an application-specific integrated circuit with an appropriate combinational logic gate circuit, a programmable gate array (PGA), a field-programmable gate array (FPGA), etc.

### Embodiment 2

Taking a certain city as a prediction region to start the experiment, according to data from the urban traffic management department, it is predicted that a number of electric vehicles in the region is 30,000, including 20,000 passenger cars, 5,000 buses and 5,000 special-purpose vehicles.

By collecting data from monitoring systems of the electric vehicles within a city, following average daily driving mileages and power consumptions are obtained:

The average daily driving mileage of one passenger car: 50 km, with a power consumption per unit driving mileage of 0.2 kWh/km.

The average daily driving mileage of one bus: 100 km, with a power consumption per unit driving mileage of 0.8 kWh/km.

The average daily driving mileage of one special-purpose vehicle: 80 km, with a power consumption per unit driving mileage of 0.5 kWh/km.

An annual charging amount for one passenger car: 365×20000×50×0.2=73,000,000 kWh.

An annual charging amount for one bus: 365×5000×100×0.8=146,000,000 kWh.

An annual charging amount for one special-purpose vehicle: 365×5000×80×0.5=73,000,000 kWh.

The charging load curves of the electric vehicles in the city across different time periods are simulated by using a Monte Carlo simulation method in combination with travel patterns and charging behaviors of the electric vehicles. According to the elasticity coefficient of electric vehicle charging and the charging price in the prediction year, the typical charging load curve is corrected. For example, the charging price of electric vehicles in the prediction year shows a certain fluctuation, and the charging load in each time period is adjusted by using the price elasticity coefficient to make it more in line with an actual situation. According to the corrected typical charging load curve, in combination with the charging amount in the prediction year, the final electric vehicle charging load in the region to be predicted in the prediction year is calculated. Experimental data is shown as Table 1.

TABLE 1
Experimental Data List

| | | | | | | Corrected |
|---|---|---|---|---|---|---|
| | | Corrected | | | Special- | special- |
| | Passenger | passenger | | Corrected | purpose | purpose |
| | car | car | Bus | bus | vehicle | vehicle |
| | charging | charging | charging | charging | charging | charging |
| | load | load | load | load | load | load |
| Time period | (kWh) | (kWh) | (kWh) | (kWh) | (kWh) | (kWh) |
| 0:00-4:00 | 5000 | 5500 | 8000 | 7200 | 6000 | 6500 |
| 4:00 AM-8:00 | 10000 | 9500 | 12000 | 10800 | 8000 | 8500 |
| 8:00 AM-12:00 | 15000 | 14000 | 16000 | 14400 | 10000 | 10500 |
| 12:00 PM-16:00 | 12000 | 13000 | 14000 | 12600 | 9000 | 9500 |
| 4:00 PM-20:00 | 18000 | 17000 | 20000 | 18000 | 15000 | 15500 |
| 8:00 PM-24:00 | 8000 | 8500 | 10000 | 9000 | 7000 | 7500 |

Correcting the charging load significantly reduces the charging load in the peak period. For example, in the peak period from 16:00 to 20:00, the passenger car charging load is reduced from 18,000 kWh to 17,000 kWh, the bus charging load is reduced from 20,000 kWh to 18,000 kWh, and the special-purpose vehicle charging load is reduced from 15,000 kWh to 15,500 kWh. This adjustment effectively smoothens the load curve and weakens a peak pressure on the power grid. After correction, the charging load in an off-peak period is increased. For example, in a time period from 0:00 to 4:00, the passenger car charging load is increased from 5,000 kWh to 5,500 kWh, and the special-purpose vehicle charging load is increased from 6,000 kWh to 6,500 kWh. This adjustment makes use of a valley period of the power grid, so as to increase the utilization rate of resources of the power grid. According to the fluctuation of charging price in the prediction year, the charging load is adjusted reasonably. For example, the charging load is increased in the time period with a lower price, while being reduced in the time period with a higher price. This not only optimizes the user's charging cost, but also increases the economic benefit of the power grid. Optimizing the charging load curve can reduce the peak load, postpone demands on power grid expansion and reconstruction, and lowers operation and maintenance costs. Applying Monte Carlo simulation and the elasticity coefficient makes the prediction results are closer to the actual charging behavior, thereby improving the accuracy and reliability of prediction.

It should be noted that the above embodiments are only used to illustrate the technical solution of the present application and are not for limitation. Although the present application is described in detail with reference to the preferred embodiments, those of ordinary skill in the art should understand that the technical solutions of the present application may be modified or replaced by equivalents without departing from the spirit and scope of the technical solutions of the present application, and all those modifications or replacements should be included in the scope of the claims of the present application.

What is claimed is:

1. A medium- and long-term prediction method for an electric vehicle charging load in consideration of an orderly charging strategy, comprising:
predicting a number of electric vehicles in a region, collecting daily driving mileage and power consumption mean values of the electric vehicles, and calculating a charging amount of the electric vehicles in a prediction year;
determining, based on a Monte Carlo simulation method and travel patterns of the electric vehicles, a typical charging load curve of the electric vehicles in the region to be predicted;
correcting, in consideration of an influence of the orderly charging strategy, the typical charging load curve of the electric vehicles in the region to be predicted according to an elasticity coefficient and a charging price in the prediction year; and
obtaining, according to the charging amount of the electric vehicles in the prediction year and the corrected typical charging load curve of the electric vehicles in the prediction year, the final electric vehicle charging load in the region to be predicted in the prediction year.

2. The medium- and long-term prediction method for the electric vehicle charging load in consideration of the orderly charging strategy according to claim 1, wherein the predicting a number of electric vehicles in a region, collecting daily driving mileage and power consumption mean values of the electric vehicles, and calculating a charging amount of the electric vehicles in a prediction year comprises, wherein the electric vehicles comprise passenger cars, buses and special-purpose vehicles:
predicting, according to contents of economic and social development planning, urban and rural planning, land comprehensive utilization planning, environmental protection planning, intelligent transportation planning, cultural and eco-tourism planning, electric vehicle and charging service industry planning and smart grid planning in the region to be predicted, the number of the electric vehicles in the region to be predicted in the prediction year;
acquiring the daily driving mileage mean value of the electric vehicles and a power consumption of the electric vehicles; and
calculating the charging amount with respect to the electric vehicle charging load in the prediction year, wherein the formula is expressed as:
$$TC = 365 \times ( N 1 \times A 1 \times B 1 + N 2 \times A 2 \times B 2 + N 3 \times A 3 \times B 3 )$$
wherein a formula for a charging amount for the passenger car in the prediction year is expressed as:
$${TC}_{1} = 365 \times {N}_{1} \times {A}_{1} \times {B}_{1}$$
a formula for a charging amount for the bus in the prediction year is expressed as:
$${TC}_{2} = 365 \times {N}_{2} \times {A}_{2} \times {B}_{2}$$
a formula for a charging amount for the special-purpose vehicle in the prediction year is expressed as:
$${TC}_{3} = 365 \times {N}_{3} \times {A}_{3} \times {B}_{3}$$
wherein N₁ is a number of the passenger cars in the prediction region in the prediction year; A₁ represents an average daily driving mileage mean value of the passenger cars; B₁ represents a power consumption per unit driving mileage of the passenger cars; TC₁ represents a total charging amount of the passenger cars in the prediction year; N₂ represents a number of the buses in the prediction region in the prediction year; A₂ represents an average daily driving mileage of the bus; B₂ represents a power consumption per unit driving mileage of the bus; TC₂ represents a total charging amount of the buses in the prediction year; N₃ represents a number of the special-purpose vehicles in the prediction region in the prediction year; B₃ represents a power consumption per unit driving mileage of the special-purpose vehicle; and TC₃ represents a total charging amount of the special-purpose vehicle in the prediction year.

3. The medium- and long-term prediction method for the electric vehicle charging load in consideration of the orderly charging strategy according to claim 2, wherein the determining, based on a Monte Carlo simulation method and travel patterns of the electric vehicles, a typical charging load curve of the electric vehicles in the region to be predicted comprises:
letting a daily driving distance s1 of passenger car in the region to be predicted conform to lognormal distribution, wherein a probability density function is expressed as:
$${f}_{st 1} = \frac{1}{s 1 {σ}_{s 1} \sqrt{2 π}} exp ( - \frac{{( lns 1 - {μ}_{s 1} )}^{2}}{2 {σ}_{s 1}^{2}} )$$
wherein fₛ₁ represents the probability density function of the daily driving distance s1 of one passenger car in the region to be predicted; s1 is a specific value of the daily driving distance of one passenger car; σₛ₁ represents a logarithmic standard deviation of the daily driving distances s1 of the passenger cars; and μₛ₁ represents a logarithm mean value of the daily driving distances s1 of the passenger cars;
letting charging start times t1 of the passenger cars in the region to be predicted follow normal distribution, wherein the formula is expressed as:
$${f}_{t 1} = \frac{1}{{σ}_{t 1} \sqrt{2 π}} exp ( - \frac{{( t 1 - {μ}_{t 1} )}^{2}}{2 {σ}_{t 1}^{2}} )$$
wherein fu represents probability distribution of charging start at a specific time t1; t1 represents a specific time of the passenger car starting to be charged; σₜ₁ represents a standard deviation of the charging start times t1 of the passenger cars; and μₜ₁ represents a mean value of the charging start times t1 of the passenger cars; and
obtaining travel pattern parameters μₛ₁, σₛ₁, μₜ₁ and σₜ₁ of the passenger car in the region to be predicted from historical charging data, and generating, by using the Monte Carlo simulation method, a typical charging load curve C₁=[C₁(1), C₁(2), C₁(3), . . . , C₁(n)] for the passenger cars in the region to be predicted on the precondition of the number N₁ of the passenger cars in the region to be predicted in the prediction year, wherein C₁(1), C₁(2), C₁(3), C₁(n) represent charging load powers of the passenger car in the region to be predicted at a 1^{st} time point, a 2^{nd} time point, a 3^{rd} time point and an n^{th} time point throughout a day respectively;
letting that a daily driving route of one bus in the region to be predicted is relatively fixed, wherein a probability density function of a daily driving distance s2 is expressed as:
$${f}_{s 2} = \frac{1}{{σ}_{s 2} \sqrt{2 π}} exp ( - \frac{{( s 2 - {μ}_{s 2} )}^{2}}{2 {σ}_{s 2}^{2}} )$$
wherein fₛ₂ represents the daily driving distance of the bus in the region to be predicted; s2 represents a specific value of the daily driving distance of the bus; σₛ₂ is a standard deviation of the daily driving distances s2 of the buses; and μₛ₂ represents a mean value of the daily driving distances s2 of the buses;
letting charging start times t2 of the buses in the region to be predicted follow uniform distribution within a given time period, wherein the formula is expressed as:
$${f}_{t 2} = \frac{1}{b - a} \qquad a < t 2 < b$$
wherein t2 represents a specific value of the bus starting to be charged; a represents a lower limit of the charging start time of one bus; fₛ₂ represents a probability density function of the charging start time t2 of the bus in the region to be predicted; and t2 represents a specific time of the bus starting to be charged;
obtaining travel pattern parameters μₛ₂, σₛ₂, a and b of the bus in the region to be predicted from historical charging data; and
generating, by using the Monte Carlo simulation method, a typical charging load curve for the bus in the region to be predicted on the precondition of the number of the buses in the region to be predicted in the prediction year, wherein C₂(1), C₂(2), C₂(3), C₂(n) represent charging load powers of the bus in the region to be predicted at a 1^{st} time point, a 2^{nd} time point, a 3^{rd} time point and an n^{th} time point throughout a day respectively; and
letting that a daily driving mileage of one special-purpose vehicle in the region to be predicted exhibits a significant fluctuation, wherein a probability density function of the daily driving distance s3 is expressed as:
$${f}_{s 3} = λ {e}^{- λ s 3}$$
wherein fₛ₃ represents the probability density function of the daily driving distance s3 of the special-purpose vehicle in the region to be predicted; s3 represents a specific value of the daily driving distance of the special-purpose vehicle; and 2 represents a distribution parameter;
letting a charging start times t3 of the special-purpose vehicles in the region to be predicted follow normal distribution, wherein the formula is expressed as:
$${f}_{t 3} = \frac{1}{{σ}_{t 3} \sqrt{2 π}} exp ( - \frac{{( t 1 - {μ}_{t 3} )}^{2}}{2 {σ}_{t 3}^{2}} )$$
wherein fₜ₃ represents a probability density function of the charging start time t3 of the special-purpose vehicle in the region to be predicted; t3 represents a specific time of the special-purpose vehicle starting to be charged; σₜ₃ represents a standard deviation of the charging start times t3 of the special-purpose vehicles; and μₜ₃ represents a mean value of the charging start times t3 of the special-purpose vehicles;
obtaining travel pattern parameters λ, μₜ₃ and σₜ₃ of the special-purpose vehicle in the region to be predicted from historical charging data; and
generating, by using the Monte Carlo simulation method, a typical charging load curve for the special-purpose vehicle in the region to be predicted on the precondition of the number N₃ of the special-purpose vehicles in the region to be predicted in the prediction year,
wherein C₃(1), C₃(2), C₃(3), C₃(n) represent charging load powers of the special-purpose vehicle in the region to be predicted at a 1^{st} time point, a 2^{nd} time point, a 3^{rd} time point and an n^{th} time point throughout a day respectively.

4. The medium- and long-term prediction method for the electric vehicle charging load in consideration of the orderly charging strategy according to claim 3, wherein the correcting, in consideration of an influence of the orderly charging strategy, the typical charging load curve of the electric vehicles in the region to be predicted according to an elasticity coefficient and a charging price in the prediction year comprises: establishing a Nash equilibrium model for the passenger cars participating in orderly charging in the region to be predicted, and determining an elasticity coefficient α1 of the passenger car in the region to be predicted, wherein the formula is expressed as:
$${F}_{1} = - {\sum }_{i = 1}^{n} {P}_{1} ( i ) \cdot {Ch}_{1} ( i ) \cdot Δ t + {FI}_{1}$$
wherein F₁ represents a main profit of the passenger car participating in the orderly charging strategy; P₁ represents a charging price at an i^{th} time point throughout a day; Ch₁(i) represents a charging power at the i^{th} time point throughout a day; Δt represents an interval time between adjacent time points; and FI₁ represents an average daily charging cost of the passenger car not participating in orderly charging;
in a case of the passenger cars in the region to be predicted participating in the orderly charging strategy, a formula for a main profit available to the power grid may be expressed as:
$${F}_{2} = {T}_{1 a} \cdot max ( {C}_{1} ( i ) - {Ch}_{1} ( i ) ) + {α}_{1 b} \cdot max ( {C}_{1} ( i ) - {Ch}_{1} ( i ) ) \cdot {β}_{1 b} + {δ}_{1 c} \cdot max ( {C}_{1} ( i ) - {Ch}_{1} ( i ) )$$
wherein F₂ represents a main profit of the power grid after the passenger cars participate in the orderly charging strategy; T₁ₐ represents a cost per unit capacity of a transformer; max(C₁(i)-Ch₁(i)) represents a maximum charging power curtailment at the i^{th} time point throughout a day; α_{1b} represents a daily equivalent utilization coefficient of a distribution line where a charging station is located; β_{1b} represents a loss cost per unit power of the distribution line; and δ_{1c} represents a benefit derived from postponed power grid reconstruction engineering per unit power curtailment; and
during cooperative operation, all participating entities in the game seek to maximize own interests, and the Nash equilibrium model formula is expressed as follows:
$$\{ \begin{matrix}F = [ max ( {F}_{1} ) + max ( {F}_{2} ) ] \\ {F}_{1} > 0 ; {F}_{2} > 0\end{matrix}$$
wherein F represents a total profit of a system; max(F₁) represents a maximum profit available to the passenger car by means of the orderly charging strategy; max(F₂) represents a maximum profit available to the power grid by means of the orderly charging strategy for the passenger cars; F₁ represents a profit of the passenger car participating in the orderly charging strategy; F₂ represents a profit of the power grid after the passenger cars participate in the orderly charging strategy; F₁>0 represents the profit of the passenger car needing to be positive; F₂>0 represents the profit of the power grid needing to be positive.

5. The medium- and long-term prediction method for the electric vehicle charging load in consideration of the orderly charging strategy according to claim 4, wherein the correcting, in consideration of an influence of the orderly charging strategy, the typical charging load curve of the electric vehicles in the region to be predicted according to an elasticity coefficient and a charging price in the prediction year further comprises: obtaining an orderly charging power of the passenger car in the region to be predicted by solving the established Nash equilibrium model, comprising: simultaneously influencing F₁ and F₂ in the Nash equilibrium model by an orderly charging power sequence of the passenger cars at different times, which is a non-convex nonlinear optimization problem; converting the problem into two subproblems for solution, wherein one subproblem is to maximize a total benefit F₃ of the benefit derived from orderly charging of the passenger cars and the benefit available to the power grid, and the formula is expressed as:
$${F}_{3} = - {\sum }_{i = 1}^{n} {P}_{1} ( i ) \cdot {Ch}_{1} ( i ) \cdot Δ t + {FI}_{1} + {T}_{1 a} \cdot max ( {C}_{1} ( i ) - C {h}_{1} ( i ) ) + {α}_{1 b} \cdot max ( {C}_{1} ( i ) - {Ch}_{1} ( i ) ) \cdot {β}_{1 b} + {δ}_{1 c} \cdot max ( {C}_{1} ( i ) - {Ch}_{1} ( i ) )$$
wherein F₃ represents a comprehensive profit of the passenger car and the power grid following the orderly charging strategy; P₁(i) represents a charging price at the i^{th} time point throughout a day; Ch₁(i) represents a charging power at the i^{th} time point throughout a day; Δt represents an interval time between adjacent time points; FI₁ represents an average daily charging cost of the passenger car not participating in orderly charging; T₁ₐ represents the cost per unit capacity of the transformer; max(C₁(i)-Ch₁(i)) represents the maximum charging power curtailment at the i^{th} time point throughout a day; α₁ represents the daily equivalent utilization coefficient of the distribution line where the charging station is located; β_{1b} represents the loss cost per unit power of the distribution line; and δ_{1c} represents the benefit derived from the postponed power grid reconstruction engineering per unit power curtailment; and
the other subproblem is to most equitably distributing the benefit derived from orderly charging of the passenger cars and the benefit available to the power grid, and the formula is expressed as:
$${F}_{4} = ln [ - {\sum }_{i = 1}^{n} {F}_{1} ( i ) \cdot {Cl}_{1} ( i ) \cdot Δ t + {FI}_{1} ] + ln [ {T}_{1 a} \cdot max ( {C}_{1} ( i ) ‐ {Cl}_{1} ( i ) ) ] + {c}_{1 b} \cdot max ( {C}_{1} ( i ) - {Cl}_{1} ( i ) ) \cdot {β}_{1 b} + {δ}_{1 c} \cdot max ( {C}_{1} ( i ) - {Cl}_{1} ( i ) )$$
wherein F₄ represents a logarithmic comprehensive profit of the system; F₁(i) represents a charging price at the i^{th} time point; Cl₁(i) represents a charging power at the i^{th} time point; Δt represents an interval time between adjacent time points; FI₁ represents an average daily charging cost of the passenger car not participating in orderly charging; T₁ₐ represents the cost per unit capacity of the transformer; c_{1b} represents the daily equivalent utilization coefficient of the distribution line; β_{1b} represents the loss cost per unit power of the distribution line; and δ_{1c} represents the benefit derived from the postponed power grid reconstruction engineering per unit power curtailment.

6. The medium- and long-term prediction method for the electric vehicle charging load in consideration of the orderly charging strategy according to claim 5, wherein the correcting, in consideration of an influence of the orderly charging strategy, the typical charging load curve of the electric vehicles in the region to be predicted according to an elasticity coefficient and a charging price in the prediction year further comprises: solving the two subproblems by means of a conventional convex optimization algorithm to ensure maximize F₃ and F₄; completing solution of the established Nash equilibrium model; and yielding the charging power Ch₁(i) of the passenger car participating in the orderly charging strategy in the region to be predicted at the i^{th} time point throughout a day to obtain the elasticity coefficient α₁ of the passenger car in the region to be predicted, wherein the formula is expressed as:
$${α}_{1} = \frac{{Ch}_{1} ( i )}{{C}_{1} ( i )}$$
the elasticity coefficient α₃ of the special-purpose vehicle in the region to be predicted is determined by using a Nash equilibrium theory, a benefit of the special-purpose vehicles participating in the orderly charging strategy in the region to be predicted is derived from the main profit F₃₁, and the formula is expressed as:
$${F}_{31} = {\sum }_{i = 1}^{n} {P}_{3} ( i ) \cdot {Ch}_{3} ( i ) \cdot Δ t - {FI}_{3}$$
wherein F₃₁ represents a main profit of the special-purpose vehicle participating in the orderly charging strategy; P₃(i) represents a charging price at the i^{th} time point throughout a day; Ch₃(i) represents a charging power at the i^{th} time point throughout a day; Δt represents an interval time between adjacent time points; and FI₃ represents an average daily charging cost of the special-purpose vehicle not participating in orderly charging;
in a case of the special-purpose vehicles in the region to be predicted participating in the orderly charging strategy, a formula for a main profit F₃₂ available to the power grid may be expressed as:
$${F}_{32} = {T}_{3 a} \cdot max ( {C}_{3} ( i ) - {Ch}_{3} ( i ) ) + {α}_{3 b} \cdot max ( {C}_{3} ( i ) - {Ch}_{3} ( i ) ) \cdot {β}_{3 b} + {δ}_{3 c} \cdot max ( {C}_{3} ( i ) - {Ch}_{3} ( i ) )$$
wherein F₃₂ represents a main profit of the power grid after the special-purpose vehicles participate in the orderly charging strategy; T₃ₐ represents a cost per unit capacity of the transformer; C₃(i) represents a charging load curve value at the i^{th} time point throughout a day; Ch₃(i) represents a charging power at the i^{th} time point throughout a day; α_{3b} represents a daily equivalent utilization coefficient of the distribution line where the charging station is located; β_{3b} represents a loss cost per unit power of the distribution line; and δ_{3c} represents a benefit derived from postponed power grid reconstruction engineering per unit power curtailment; and
during cooperative operation, all participating entities in the game seek to maximize own interests, and the Nash equilibrium model is as follows:
$$\{ \begin{matrix}F = [ max ( {F}_{31} ) + max ( {F}_{32} ) ] \\ {F}_{31} > 0 ; {F}_{32} > 0\end{matrix}$$
yielding, by solving an optimization formula, the charging power Ch₃(i) of the special-purpose vehicle participating in orderly charging in the region to be predicted at the i^{th} time point throughout a day, and obtaining the elasticity coefficient α₃ of the passenger car in the region to be predicted, specifically as follows:
$${α}_{3} = \frac{{Ch}_{3} ( i )}{{C}_{3} ( i )}$$
according to the elasticity coefficient α₁ of the passenger car in the region to be predicted and the charging price in the prediction year, P₁(1), P₁(2), P₁(3), and P₁(n) represent charging prices of the passenger car in the region to be predicted at the 1^{st} time point, the 2^{nd} time point, the 3^{rd} time point and the n^{th} time point throughout a day respectively;
a yielded typical charging load curve of the passenger cars in the region to be predicted is expressed as:
$${C}_{1 z} ( i ) = {α}_{1} \times \frac{max ( {P}_{1} ) + min ( {P}_{1} )}{2 {P}_{1} ( i )} \times {C}_{1} ( i ) , 1 \leq i \leq n$$
wherein C_{1z}=[C_{1z}(1), C_{1z}(2), C_{1z}(3), . . . , C_{1z}(n)], C_{1z}(1), C_{1z}(2), C_{1z}(3), C_{1z}(n) represent corrected charging load powers of the passenger cars in the region to be predicted at the 1^{st} time point, the 2^{nd} time point, the 3^{rd} time point and the n^{th} time point throughout a day respectively,
wherein C_{1z}(i) represents an adjusted charging load power of the passenger car at the i^{th} time point throughout a day; α₁ represents an elasticity coefficient of the passenger car; max(P₁) represents a maximum charging price throughout a day; min(P₁) represents a minimum charging price throughout a day; P₁(i) represents a charging price at the i^{th} time point throughout a day; C₁(i) represents an original charging load power of the passenger car at the i^{th} time point throughout a day; and 1≤i≤n represents a range of the time point i; and
according to the elasticity coefficient α₃ of the special-purpose vehicle in the region to be predicted and the charging price P₃=[P₃(1), P₃(2), P₃(3), . . . , P₃(n in the prediction year,)], P₃(1), P₃(2), P₃(3), P₃(n) represent charging prices of the special-purpose vehicle in the region to be predicted at the 1^{st} time point, the 2^{nd} time point, the 3^{rd} time point and the n^{th} time point throughout a day respectively;
a corrected typical charging load curve of the special-purpose vehicles in the region to be predicted is expressed as:
$${C}_{3} = [ {C}_{3} ( 1 ) , {C}_{3} ( 2 ) , {C}_{3} ( 3 ) , … , {C}_{3} ( n ) ]$$
$${C}_{3 z} = [ {C}_{3 z} ( 1 ) , {C}_{3 z} ( 2 ) , {C}_{3 z} ( 3 ) , … , {C}_{3 z} ( n ) ]$$
wherein C_{3z}(1), C_{3z}(2), C_{3z}(3), C_{3z}(n) represent corrected charging load powers of the special-purpose vehicle in the region to be predicted at a 1^{st} time point, a 2^{nd} time point, a 3^{rd} time point and an n^{th} time point throughout a day respectively;
$${C}_{3 z} ( i ) = {α}_{3} \times \frac{2 max ( {P}_{3} ) + min ( {P}_{3} )}{3 {P}_{3} ( i )} \times {C}_{3} ( i ) , 1 \leq i \leq n$$
wherein C_{3z}(i) represents an adjusted charging load power of the special-purpose vehicle at the i^{th} time point throughout a day; α₃ represents an elasticity coefficient of the special-purpose vehicle; max(P₃) represents a maximum charging price throughout a day; min(P₃) represents a minimum charging price throughout a day; P₃(i) represents a charging price at the i^{th} time point throughout a day; C₃(i) represents an original charging load power of the passenger car at the i^{th} time point throughout a day; and 1≤i≤n represents a range of the time point i.

7. The medium- and long-term prediction method for the electric vehicle charging load in consideration of the orderly charging strategy according to claim 6, wherein the obtaining, according to the charging amount of the electric vehicles in the prediction year and the corrected typical charging load curve of the various electric vehicles in the prediction year, the final electric vehicle charging load in the region to be predicted in the prediction year comprises: solving a charging load prediction coefficient F1 of the passenger car in the region to be predicted in the prediction year, specifically as follows:
$${F}_{1} = \frac{{N}_{1} \times {A}_{1}}{[ 365 \times \frac{24}{n} {\sum }_{i = 1}^{n} {C}_{1 z} ( i ) ]}$$
solving a charging load prediction coefficient F₂ of the bus in the region to be predicted in the prediction year, specifically as follows:
$${F}_{2} = \frac{{N}_{2} \times {A}_{2}}{[ 365 \times \frac{24}{n} {\sum }_{i = 1}^{n} {C}_{2} ( i ) ]}$$
solving a charging load prediction coefficient F₃ of the special-purpose vehicle in the region to be predicted in the prediction year, specifically as follows:
$${F}_{3} = \frac{{N}_{3} \times {A}_{3}}{[ 365 \times \frac{24}{n} {\sum }_{i = 1}^{n} {C}_{3 z} ( i ) ]}$$
and yielding a final electric vehicle charging load in the region to be predicted in the prediction year LP=[LP(1), LP(2), LP(3), . . . , LP(n)], specifically as follows:
$$LP ( i ) = {F}_{1} \times {C}_{1 z} ( i ) + {F}_{2} \times {C}_{2} ( i ) + {F}_{3} \times {C}_{3 z} ( i ) \qquad 1 < i \leq n$$
wherein F₁ represents the charging load prediction coefficient of the passenger car; N₁ represents the number of the passenger cars in the prediction region in the prediction year; A₁ represents the average daily driving mileage of the passenger car; F₂ represents the charging load prediction coefficient of the bus; N₂ represents the number of the buses in the prediction region in the prediction year; A₂ represents the average daily driving mileage of the bus; F₃ represents the charging load prediction coefficient of the special-purpose vehicle; N₃ represents the number of the special-purpose vehicles in the prediction region in the prediction year; A₃ represents the average daily driving mileage of the special-purpose vehicle.

8. A medium- and long-term prediction system for an electric vehicle charging load in consideration of an orderly charging strategy using the method according to claim 1, comprising:
a prediction module, configured to predict a number of electric vehicles in a region, collecting daily driving mileage and power consumption mean values of the electric vehicles, and calculating a charging amount of the electric vehicles in a prediction year;
a determining module, configured to determine, based on a Monte Carlo simulation method and travel patterns of the electric vehicles, a typical charging load curve of the electric vehicles in the region to be predicted;
a correcting module, configured to correct, in consideration of an influence of the orderly charging strategy, the typical charging load curve of the electric vehicles in the region to be predicted according to an elasticity coefficient and a charging price in the prediction year; and
a result module, configured to obtain, according to the charging amount of the electric vehicles in the prediction year and the corrected typical charging load curve of the electric vehicles in the prediction year, the final electric vehicle charging load in the region to be predicted in the prediction year.

9. An electronic device, comprising a memory and a processor, wherein the memory has a computer program stored thereon, and the processor implements, when executing the computer program, steps of a medium- and long-term prediction method for an electric vehicle charging load in consideration of an orderly charging strategy.

10. A computer-readable storage medium in which a computer program is stored, wherein when the computer program is executed by a processor, the steps of a medium- and long-term prediction method for an electric vehicle charging load in consideration of an orderly charging strategy are implemented.
